(19) United States
(12) Patent Application Publication
(10) Pub. No.: US 2009/0308810 A1
(43) Pub. Date: Dec. 17, 2009

(54) Separation Apparatus and Method

(75) Inventor: Jan Cornelis de Koning, Zwijndrecht (NL)

Correspondence Address: SWANSON & BRATSCHUN, L.L.C., 8210 SOUTHPARK TERRACE, LITTLETON, CO, 80120, US

(73) Assignee: ZONNEWATER B.V., Zwijndrecht (NL)

(21) Appl. No.: 11/995,800

(22) PCT Filed: Jul. 15, 2005
(86) PCT No.: PCT/NL2005/000515

§ 371 Date: Mar. 17, 2008

(51) Int. Cl. C02F 1/04

(52) U.S. Cl. 210/640; 210/180

(57) ABSTRACT

The invention relates to a separation apparatus for separating a liquid from a solution, in particular fresh water from seawater. The separation apparatus comprises an evaporation space in which operatively an amount of the solution is present from which a liquid vapor evaporates under the influence of heat. The separation apparatus further comprises a condensation space which is in connection with the evaporation space via a condensation tube and which is arranged for condensing liquid vapor. The separation apparatus also comprises a flow-through device for transporting the liquid vapor from the evaporation space to the condensation space, wherein the flow-through device is arranged for intermittently transporting the liquid vapor.

The invention relates to a separation apparatus for separating a liquid from a solution, in particular fresh water from seawater, comprising an evaporation space in which operatively an amount of the solution is present from which a liquid vapor evaporates under the influence of heat, and a condensation space which is in connection with the evaporation space via a condensation tube and which is arranged for condensing the liquid vapor, further comprising a flow-through device for transporting the liquid vapor from the evaporation space to the condensation space.

Such a separation apparatus is known from Canadian patent publication CA 2 308 805 in which a desalination system is described. In the evaporation space, an amount of seawater is provided from which water vapor is created under the influence of solar energy. Via the condensation tube, the water vapor flows to a separate condensation space where precipitation to fresh water takes place. A flow-through device designed as a vacuum pump ensures that a flow of water vapor is forced from the evaporation space to the condensation space.

With the aid of such desalination systems, fresh water can be obtained from seawater, so that, in areas where seawater and sunlight are, unlike fresh water, widely available, drinking water can still be obtained relatively easily. However, the production of the fresh water is low.

The invention contemplates a separation apparatus of the type mentioned in the introduction, where, while preserving the advantages, the disadvantages mentioned are obviated. In particular, the invention contemplates a separation apparatus where the production of the liquid can be increased. To this end, the flow-through apparatus is designed for intermittently transporting the liquid vapor.

By intermittently transporting the liquid vapor from the evaporation space to the condensation space, in a surprising manner, a higher production of precipitated liquid is obtained. A physical explanation for this phenomenon may be that the condensation process is accelerated if the liquid vapor is at rest for some time and/or that, with a continuously flowing liquid vapor, apart from condensation, a part can evaporate again directly thereupon. With intermittent, so batchwise transport of the liquid vapor, the vapor can settle down after each transport period, so that gas flows, and any associated turbulences, decrease or even completely disappear in the condensation space during the period of rest, resulting in an increase of the desired condensed liquid.

It is noted that American patent publication U.S. Pat. No. 4,518,503 describes a water purification device for batchwise purification of drinking water. Water vapor in an evaporation space is brought to a condensation space via a connection which is not arranged for intermittently transporting liquid vapor.

It is further noted that French patent publication FR 1 097 030 describes a distillation process for removing gases from a liquid. In the system as described in FR '030, there is no connection for transporting liquid vapor from a condensation space to an evaporation space.

Preferably, the flow-through device is arranged for substantially periodically transporting the liquid vapor, so that the control can be implemented relatively simply.

By choosing the period in which transport of the liquid vapor takes place so as to be relatively short, a separation apparatus is obtained where a relatively large amount of liquid vapor can be transported from the evaporation space to the condensation space, while the transported liquid vapor can still stagnate in the condensation space. This further increases the production of liquid.

In an advantageous manner, in the evaporation space, a cloth can be provided of which operatively a part reaches into the amount of solution. It is thus achieved that the amount of solution is soaked into the cloth due to capillary action, so that the surface of the solution which is adjacent to the gas present in the evaporation space increases.

By building up the cloth from a multiple number of strips, of which operatively each has a part which reaches into the amount, of solution, the surface of the solution which is operatively adjacent to the gas present in the evaporation space is increased still further, so that the evaporation process, and consequently the production of liquid also accelerates.

It is noted that use of a cloth built up from a multiple number strips, of which operatively each has a part which reaches into the amount of solution, is not limited to the separation apparatus according to claim 1. Thus, the cloth built up from a multiple number of strips can also be used in a salt basin, in which operatively seawater is stored which evaporates under the influence of sun and wind, so that sea salt initially dissolved in the seawater remains behind in the salt basin as a residue. Since the surface seawater which is in contact with sunlight and air artificially increases due to the cloth built up from a multiple number of strips, the evaporation process, and consequently the production of sea salt, will accelerate. Preferably, multiple salt basins connectable to one another are placed in one another's proximity, so that a salt production can be obtained all year round. By using the cloth built up from a multiple number of strips in the salt basins, the salt production can increase and/or the area of salt basins can be reduced. The strips of cloth may, for instance, be suspended from optionally locally supported cables. Preferably, the strips of cloth are designed in black, so that the thermal action of the sunlight is utilized as much as possible. In order to prevent growth of salt crystals on the cloth, the cloth preferably comprises a carton-like material, such as tissue paper, which has a relatively low cost price and can easily be removed from the evaporated salt. In use in a salt basin in which no or relatively little salt growth takes place, other material can also be used for the cloth, such as textile.

The invention further relates to a method for separating a liquid from a solution.

Further advantageous embodiments of the invention are given in the subclaims.

The invention will be explained in more detail on the basis of exemplary embodiments shown in the drawings, in which:

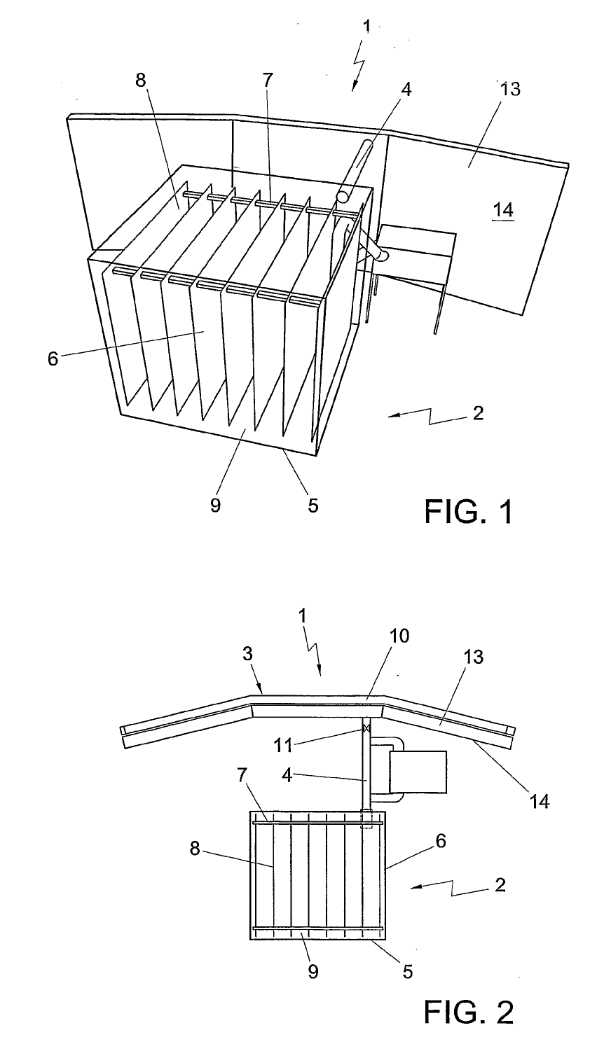

FIG. 1 shows a schematic perspective view of a separation apparatus according to the invention;

FIG. 2 shows a schematic top plan view of the separation apparatus of FIG. 1;

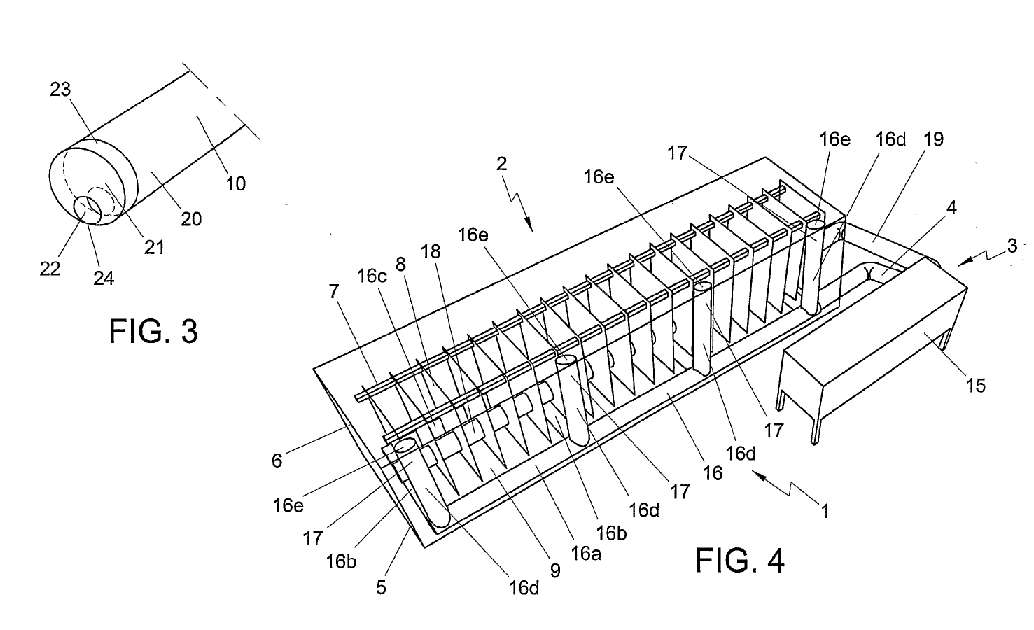

FIG. 3 shows a schematic perspective view of a condensation pipe and closing device; and

FIG. 4 shows a schematic perspective view of a different separation apparatus according to the invention.

The Figures are only schematic representations of preferred embodiments of the invention. In the Figures, same or corresponding parts are designated by the same reference numerals.

FIGS. 1 and 2 show a preferred embodiment of a separation apparatus 1 according to the invention. The separation apparatus 1 has an evaporation space 2 and a condensation space 3 which are in connection with each other via a condensation tube 4. The evaporation space 2 is enclosed by a radiation-transmitting construction, designed as a frame 5, in which glass plates 6 are included. Due to the radiation-transmitting construction, which acts as a greenhouse, the temperature in the evaporation space 2 can rise considerably under the influence of sunlight. In the evaporation space 2, a rack 7 is set up from which a multiple number of strips 8 of cloth are suspended.

In use of the separation apparatus 1, an amount of seawater 9 is present in the evaporation space 2, which is a solution of water with inter alia minerals and salts. With the aid of the separation apparatus 1, also called desalination system, the water can be separated from the sea salts dissolved therein in a relatively quick manner. The multiple strips 8 of cloth each reach into the seawater, so that the cloth is moistened through capillary action. Due to the relatively high temperature in the evaporation space 2, for instance 90° C., and the relatively large surface of seawater 9 which is in contact with the air in the evaporation space 2, an evaporation process comes into operation in which a water vapor is created. Via the condensation tube 4, the liquid vapor, which hardly contains any salt, flows to the condensation space 3, where the liquid vapor condenses, so that fresh water is obtained. In the evaporation space 2, seawater with a larger concentration of salt remains behind. After evaporation of all water, practically all sea salt which was present in the seawater remains behind as a residue.

The condensation space 3 is designed as a condensation pipe 10 which is preferably white on the outside, so that heating up of the condensation space 3 as a result of directly incident sunlight is minimized. The fresh water which precipitates in the condensation pipe 10 is collected, for instance in a reservoir, or is available with the aid of access means, such as a tap. As FIG. 3 shows, in an advantageous manner, the condensation pipe 10, at an end 20, may be provided with a closing device 21 having an opening 22, for instance designed as a disc with a hole, also called restriction. It is thereby achieved that the water vapor transported to the condensation space 3 cannot leave the condensation pipe 10 easily, but somewhat stagnates, so that the process of condensing is speeded up. Through the opening 22 in the closing device 21, the condensed water can be discharged. By providing the opening 22 eccentrically, adjacent to the lowest point 24 of the edge 23 of the closing device 21, condensed water is prevented from remaining in the condensation pipe 10, which would be undesired for reasons of hygiene. The condensation pipe 10 preferably comprises heat-absorbing material, such as pebbles or stones, so that the temperature in the condensation pipe also stays relatively low during the day. This increases the amount of condensed fresh water in an advantageous manner. The cooled air is fed back to the evaporation space 2. However, it is also possible to supply fresh outside air to the evaporation space 2.

The separation apparatus 1 further comprises a flow-through device, designed as an electric fan 11 acting as a pump which is set up in the condensation tube 4. Preferably, the electric fan is driven by solar and/or wind energy, for instance with the aid of solar cells and/or a wind turbine, so that no external electrical energy is needed for the operation of the separation apparatus 1. The fan 11 transports water vapor from the evaporation space 2 to the condensation space 3. The drive of the fan 11 is such that the liquid vapor is transported intermittently, batchwise, so that an efficient condensation can take place. Here, the fan is switched on and off periodically. In this manner, the fan can transport the liquid vapor relatively briefly, for instance for a period of about 5 seconds, after which an inactive period, for instance a period of about 4 seconds, follows. So, the total cycle takes up about 10 seconds, which may also be shorter, however, for instance about 5 seconds, or longer, for instance about half a minute. Also, the part of the cycle in which the fan is actually driven may vary.

It is noted that the flow-through device may also be implemented as a different module with a pumping action, for instance with the aid of blades. Further, the pump may also derive its action from compression and/or suction utility. Further, the pump may be set up in or near the condensation tube 4, for instance in the evaporation space 2 or in the condensation space 3. In addition, it is also possible to design the flow-through device with different mechanical elements, for instance with the aid of a valve system which enables periodic flow of water vapor from the evaporation space 2 to the condensation space 3 depending on vapor pressures built up.

In an advantageous embodiment, the separation apparatus 1 comprises a partition 13 which is placed between the evaporation space 2 and the condensation space 3. It is thereby achieved that, with wind from particular wind directions, the condensation space 3 is cooled by the air flowing past, while the evaporation space 2 does not lose any extra heat, since the evaporation space 2 is then placed out of the wind. This increases the heat difference between the condensation space 3 and the evaporation space 2, which accelerates the production of fresh water. The construction with the partition 13 is particularly favorable with strong wind and/or when the wind usually blows from a substantially fixed direction, like in the Caribbean. Preferably, the partition comprises glass, so that sunlight can also radiate the evaporation space 2 through the glass of the partition 13. This promotes the direct incidence of light in the evaporation space 2, also when the evaporation space 2 is on the shady side of the partition 13. By designing the glass of the partition 13 so as to be reflective on the side 14 facing the evaporation space 2, it is achieved that the shady side of the evaporation space 2 is also radiated by the sun, albeit indirectly. Here, the direct sunlight is incident on the reflecting glass on the side 14 of the partition 13 facing the evaporation space 2 and can thus still be incident on the evaporation space 2, so that the temperature in the evaporation space 2 can rise still further, while, with a different position of the sun, still incidence of light through the partition 13 to the evaporation space 2 remains possible. Preferably, the side 14 of the partition 13 facing the evaporation space 2 has a curve bending away in the direction of the evaporation space 2, so that the light incident on the partition 13 can be focused towards the evaporation space 2, which increases the heat production still further.

FIG. 4 shows a further preferred embodiment of the separation apparatus 1 according to the invention. The evaporation space 2 has a similar design, with a frame 5, glass plates 6, a rack 7, a multiple number of strips 8 of cloth. In use, in the evaporation space 2, an amount of seawater is present which evaporates as a result of sunlight and is collected in the condensation space 3. The flow-through device is not shown explicitly in the Figure. The embodiment shown in FIG. 4 comprises no partition and is particularly suitable for desertlike areas where ambient temperatures run high and where usually no appreciable wind can be found. The condensation space 3 comprises a cooling device included in a separate chamber 15. The chamber comprises, for instance, an above-described condensation pipe and/or heat-absorbing material, in order to obtain a lowest possible temperature. The condensation space 3 further extends via a connecting tube 4 into a tube system 16 in the evaporation space 2. The tube system 16 comprises a number of horizontal tubes 16a, 16c connected with each other via tubes 16b oriented transversely thereto. Further, the tube system 16 comprises a number of upstanding tubes 16d which take in the water vapor via an open end 16e. Each upper part of the upstanding tubes 16d thus forms, with the respective open ends 16e, a condensation tube 17 through which the water vapor can be transported from the evaporation space 2 to the condensation space 3. Thus, the condensation space 3 comprises the cooling device in the chamber 15, the connecting tube 4 and the interior space of the lower part of the tube system 16. In an advantageous manner, the lower part of the tube system 16 may be wrapped with cloth of which a part reaches into the amount of seawater, so that the water vapor in the tube system 16 is already cooled with the seawater before the water vapor is fed to the separate chamber 15. Thereby a better cooling can be obtained and/or the heat capacity of the material in the chamber 15 is used less. The cooled air leaves the separate chamber 15 via a second connecting tube 19 which, via an inlet tube 18, opens into the interior of the evaporation space 2, where the air can be saturated again with evaporated seawater. Of course, the tube system 16 can also be designed in different manners. As appears from the exemplary embodiments described in the application, the condensation space 3 may be located both outside the evaporation space, for instance with the aid of a separate apparatus, and inside the evaporation space, for instance with the aid of a tube system.

The invention is not limited to the exemplary embodiments described herein. Many variants are possible.

Thus, the evaporation space may comprise a layer of radiation-absorbing material, for instance designed in black, which surrounds at least a part of the strips of cloth. It is thereby achieved that, after sunset, temperature differences arise in the evaporation space which generate a natural air flow. The air flow makes it possible that, for some time, water vapor can successfully be discharged through the condensation tube, so that the production process of fresh water does not end abruptly after sunset, but decreases gradually, resulting in a higher total production of water per twenty-four hours.

Also, instead of a setup in which the multiple number of strips of cloth are arranged substantially next to one another, other setups can be chosen as well, for instance a setup where the cloth has at least a part of a pyramid shape of which the base reaches into the amount of seawater during use of the separation system. It is thereby achieved that, in the case of a pyramid shape with a substantially square base, at least three inclined faces of the pyramid can be radiated directly by sunlight, which will promote the evaporation process and consequently the production of fresh water.

It is further noted that such a separation apparatus cannot only be used for separating fresh water from seawater, but more generally for separating a liquid from a solution, for instance water from a solution with pollutants, or heavy metals.

Such variants will be clear to a skilled person and are understood to be within the scope of the invention as set forth in the following claims.

1. A separation apparatus for separating a liquid from a solution, comprising an evaporation space in which an amount of the solution is present from which a liquid vapor evaporates under the influence of heat, and a condensation space which is in connection with the evaporation space via a condensation tube and which is arranged for condensing liquid vapor, further comprising a flow-through device for transporting the liquid vapor from the evaporation space to the condensation space, wherein the flow-through device is arranged for intermittently transporting the liquid vapor.

2. The separation apparatus according to claim 1, wherein the flow-through device is arranged for substantially periodically transporting the liquid vapor.

3. The separation apparatus according to claim 2, wherein the period within which transport of the liquid vapor takes place is relatively short.

4. The separation apparatus according to claim 1, wherein, in the evaporation space, a cloth is provided of which operatively a part reaches into the amount of solution.

5. The separation apparatus according to claim 4, wherein the cloth is built up from a multiple number of strips of which operatively each has a part reaching into the amount of solution.

6. The separation apparatus according to claim 1, wherein the cloth at least partly has a pyramid shape of which the base operatively reaches into the amount of solution.

7. The separation apparatus according to claim 4, wherein the evaporation space further comprises a layer of radiation-absorbing material which surrounds at least a part of the cloth.

8. The separation apparatus according to claim 1, wherein the evaporation space is enclosed by a radiation-transmitting construction.

9. The separation apparatus according to claim 1, further comprising a partition placed between the evaporation space and the condensation space.

10. The separation apparatus according to claim 1, wherein the partition comprises glass.

11. The separation apparatus according to claim 10, wherein the glass of the partition is reflective on the side facing the evaporation space.

12. The separation apparatus according to claim 9, wherein a side of the partition facing the evaporation space has a curve bending away in the direction of the evaporation space.

13. The separation apparatus according to claim 1, wherein the flow-through device comprises a pump.

14. The separation apparatus according to claim 1, wherein the condensation space comprises heat-absorbing material.

15. A method for separating a liquid from a solution, comprising evaporating a liquid vapor from an amount of solution in an evaporation space under the influence of heat, intermittently transporting the liquid vapor from the evaporation space to the condensation space; and condensing the liquid vapor in a condensation space.

16. The method of claim 15 further comprising intermittently transporting the liquid vapor for a select transport period of time.

17. The method of claim 16 further comprising providing an inactive period between the select transport periods.

18. The method of claim 17 wherein the transport period is longer than the inactive period.

19. The method of claim 18 wherein a cycle consisting of the transport period and the inactive period is between about 5 and 30 seconds.

20. The separation apparatus of claim 1 wherein the solution is saline water and the liquid is fresh water.
